(19) United States
(12) Patent Application Publication
(10) Pub. No.: US 2025/0307639 A1
(43) Pub. Date: Oct. 2, 2025

(54) PROMPT MANAGEMENT FOR LARGE LANGUAGE MODEL

(71) Applicant: Amazon Technologies, Inc., Seattle, WA (US)

(72) Inventors: Minho Jin, San Jose, CA (US); Erfan Soltanmohammadi, Silver Spring, MD (US); Masahito Togami, ota-ku (JP); Gizem Tabak, San Carlos, CA (US); Turab Iqbal, Sunnyvale, CA (US); Karim Helwani, San Mateo, CA (US); Michael Mark Goodwin, Scotts Valley, CA (US)

(21) Appl. No.: 18/620,873

(22) Filed: Mar. 28, 2024

(51) Int. Cl. G06N 3/0895; G06F 18/2415

(52) U.S. Cl. CPC G06N 3/0895; G06F 18/2415

(57) ABSTRACT

Systems and methods for a prompt generation and analysis service for generating and identifying a preferred prompt for performing a function of a large language model (LLM) are provided. The prompt generation and analysis service may generate a set of training prompts for performing a function of an LLM. The prompt generation and analysis service may then query the LLM with the generated set of prompts and characterize the output of the LLM for each prompt. Using the characterization of the output and corresponding prompt, the prompt generation and analysis service can train a classifier model to classify the prompts. The prompt generation and analysis service may generate a set of target prompts for performing a function of an LLM, characterize the target prompts using the training classifier model, and identify a preferred prompt for performing the function based on the classifier model's classification.

### BACKGROUND

Generally described, computing devices and communication networks can be utilized to exchange data or information. In a common application, a computing device can request content from another computing device via the communication network. For example, a client having access to a computing device can utilize a software application to request content from a server computing device via the network (e.g., the Internet). In such embodiments, the client's computing device can be referred to as a client computing device, and the server computing device can be referred to as a content provider.

In some applications, the network service provider can instantiate various network-based services that can process client requests for data. For example, network-services related to query processing or question answering assistants (e.g., chatbots) can correspond to network-based services that interact with humans to provide information (e.g., information about a network-based service, how to use the network-based service, etc.).

### BRIEF DESCRIPTION OF DRAWINGS

Embodiments of various inventive features will now be described with reference to the following drawings. Throughout the drawings, reference numbers may be re-used to indicate correspondence between referenced elements. The drawings are provided to illustrate example embodiments described herein and are not intended to limit the scope of the disclosure. To easily identify the discussion of any particular element or act, the most significant digit(s) in a reference number typically refers to the figure number in which that element is first introduced.

FIG. 1 depicts a block diagram of an environment for a prompt generation and analysis service that includes one or more computing devices, a prompt generation and analysis service, a user application, a user account, and a communication application;

FIG. 2A is a visualization of the environment of FIG. 1 depicting illustrative interactions between the prompt generation and analysis service and a computing device for generating prompts and corresponding output using a large language model (LLM), in accordance with aspects of the present application;

FIG. 2B is a visualization of the environment of FIG. 1 depicting illustrative interactions between the prompt generation and analysis service and a computing device that may process and rank prompts, in accordance with aspects of the present application;

FIG. 3 is a visualization of the environment of FIG. 1 depicting illustrative interactions between the prompt generation and analysis service, the LLM, and a computing device that may query the LLM with an identified specified prompt, in accordance with aspects of the present application;

FIG. 4 is a flow diagram illustrative of a routine for training a classifier model, in accordance with aspects of the present application;

FIG. 5 is a flow diagram illustrative of a routine for the identification of prompts for a specified function associated with an LLM and processing a request based on an identified function using a preferred prompt, in accordance with aspects of the present application; and

FIG. 6 is a block diagram of illustrative architecture of a prompt generation and analysis service, in accordance with aspects of the present application.

### DETAILED DESCRIPTION

Generally described, aspects of the present disclosure relate to systems and methods for providing a prompt generation and analysis service incorporating one or more machine-learned algorithms configured according to large language models (LLMs), generally referred to as an “LLM.” Illustratively, various aspects of the present application correspond to training a machine-learning based classifier model based on correlating prompts to an LLM to outputs generated by the LLM, application of the machine-learning based classifier model to select preferred prompts from a set of generated target prompts corresponding to an identified function and inferenced by the machine-learning based classifier model, and a processing of requests to the LLM for identified functions according to the selected preferred prompt. Illustratively, the various aspects of the present application will be discussed sequentially and in combination. However, each of the individual aspects may be individually implemented or combined with other implementations.

Generative artificial intelligence (AI) models (e.g., LLMs, implemented by prompt generation and analysis services or chatbots, etc.) are configured to generate outputs based on received prompts. In some examples, the prompt submitted to the LLM can be characterized or organized so that the output has an identified function. For example, outputs from an LLM may be used to characterize the tone or sentiment of a speaker based on the transcription of a call, where the transcription is input data to the LLM. To cause the generation of the output, the prompt to the LLM may be in the form of natural language or textual commands, such as “Identify the tone of the speaker” or “Get sentiment from transcript,” etc. Continuing with the example, assume the transcription is a text transcription from a phone call, which includes transcribed text such as “I can't believe how great your customer service is,” or the like. In this illustrative example, the LLM processes input data (e.g., transcribed text) in accordance with the prompt and generates output indicative of a characterization of a tone of the inputted data, such as “Positive,” “Negative,” or “Neutral.” The generated output can be utilized for further processing by customer service agents, escalation processes, archival or historical processes, etc.

For any LLM, the determined performance or accuracy of various outputs may depend on the design of the prompt. Specifically, certain prompts may result in more or less accurate or appropriate output. In one aspect, a poorly written or unclear prompt can lead to outputs that include false or misleading information included in output from the LLM, such as a well-known issue associated with LLMs generally referred to as hallucinations. In another aspect, variations in the language of the prompt (including the amount of text included in the prompt) can yield variations in the quality and consistency in the output generated by LLM. For instance, there may be two prompts asking for the LLM to perform the same function, but each of the two prompts may be worded differently (e.g., “Identify the tone of the speaker” versus “Get sentiment from transcript”). In the example of tone analysis, an inaccurate result may be problematic especially when an end user may be relying on the LLM output to perform customer service based on the tone of the speaker (e.g., a customer). In situations in which the accuracy or quality of the LLM outputs is required, a service may submit the same input data to the LLM using a number of different prompts or prompt variations and compare the results. However, such an approach is computationally inefficient as each output generation from the LLM consumes a significant amount of computing and networking resources, often characterized as a “cost.” Such computational costs and inefficiencies may be more prominent in scenarios in which the number of prompts that are submitted for each individual request and the number of requests to the services scales.

To address at least the above-described deficiencies, a prompt generation and analysis service can implement one or more modules to identify a preferred prompt for performing a function of an LLM. More specifically, one or more aspects of the present application can include a prompt generation and analysis service that can generate a set of training prompts associated with a function to be submitted to an LLM. Generally described, the identified function corresponds to the desired or identified purpose of the prompt. For example, the purpose of the prompt may be to have the LLM perform a certain task, such as identify the tone of a speaker of a text transcript. The LLM can generate a set of outputs in response to each of the prompts in the set of training prompts. The prompts in the set of training prompts associated with the identified function can correspond to generated LLM outputs based on input data provided with the prompt (or otherwise accessed by the LLM).

Each individual output illustratively corresponds to, or is, a result of passing the input data and the respective prompt through the LLM, where the prompt aims to implement the identified function as applied to the input data and elicited by the specific target prompt. For example, based on the prompt, the LLM may generate outputs corresponding to numerical values for the input data, categorization of specified categories for the input data, categorization of human-specified traits or attributes for the input data, textual or graphical data based on the input data, and the like.

The outputs from the set of training prompts can be compared to an expected value (or ground truth) such that the prompt generation and analysis service can characterize the appropriateness of the output to the prompt. Thereafter, the prompt generation and analysis service can train a classifier model to evaluate the set of generated outputs corresponding to the set of target prompts. Illustratively, the prompt generation and analysis service can use the characterization data as labels to the training set for the classifier model.

In accordance with other aspects, the prompt generation and analysis service can generate a set of target prompts for the LLM based on the identified function. Using the trained classifier model, the prompt generation and analysis service can characterize each prompt as reflecting appropriate application of the identified function to the input data. Specifically, inference of the classifier model can generate outputs characterizing an appropriateness of the application of the identified function. Based on the output of the classifier model, the prompt generation and analysis service can then utilize the outputs from the classifier model to identify a default prompt for the identified function or otherwise identify a preferred prompt (or set of prompts) for the identified function. The preferred prompt may be referred to as an optimal prompt, default prompt, preferred prompt, and the like. In this regard, the prompt generation and analysis service does not have to create the output from the LLM and compare the results. The default prompt can also be referred to as a preferred prompt.

The prompt generation and analysis service can be used as a general LLM prompt optimizer where no storage of the prompts is required and no explicit identified function is needed. For example, the prompt generation and analysis service can receive (or retrieve) an identified prompt and generate a finite number of variations of that prompt (e.g., using an LLM or other prompt generation method). The prompt generation and analysis service can then process the finite set of prompts with a classifier to identify a preferred prompt. The prompt generation and analysis service can then pass the preferred prompt through the target LLM and obtain an output. In this way, the prompt generation and analysis service can provide a preferred prompt (e.g., responsive to a user request or initial submission) without requiring the user (or other system) to manually submit multiple prompts or attempt multiple iterations of the LLM processing alternative prompts.

In one embodiment, one or more aspects of the present application can include the prompt generation and analysis service storing the one or more preferred prompt(s) for later use in a data store in order to be used in subsequent requests to the LLM such that a smaller number of prompts are submitted to the LLM per request. The computing device may request to perform a function using the LLM. Then, the prompt generation and analysis service can identify at least one of the stored preferred prompts in the data store and then query the LLM with that identified preferred prompt. The LLM can then output content in response to the preferred prompt.

In this way, the efficiency and performance of the system is improved by predetermining prompt(s) which are characterized as appropriately generated output from the LLM for an identified function. In this regard, as part of the selection process, a prompt generation and analysis service can consider a larger number of target prompts, evaluate the larger number of target prompts against performance criteria, and select even a single default or preferred prompt that will be used in processing subsequent results. The number and variations of the initial set of target prompts can include wider variations to have a greater likelihood that preferred and non-preferred target prompts are identified. Additionally, by reducing the identified prompt (including to a single prompt), the processing of the subsequent requests provides significant computational efficiencies and performance benefits for the prompt generation and analysis service.

In another embodiment, the prompt generation and analysis service can implement an iterative process based on a measured/characterized quality of LLM output. Illustratively, the prompt generation and analysis service can identify a prompt (e.g., a user submitted prompt, a dynamically generated prompt, a default prompt, and the like. The prompt generation and analysis service can then pass, or submit, the prompt through the LLM for processing and receive an output.

The prompt generation and analysis service can assess the quality of the received output of the LLM using a quality metric or set of quality metrics. For example, the quality metric may include metrics based on instances of hallucination, poor context retrievals, harmful responses, incorrect formatting, and the like. The quality metric can also include various combinations or weighted combinations of individual quality metrics. The prompt generation and analysis service can determine that the quality of the metric(s) falls below a threshold so that the output will not be provided or otherwise is identified/labeled. The prompt generation and analysis service can then generate alternative prompts to the submitted prompt, such as by using automated systems that generate alternative prompts, machine-learned algorithms, or pre-defined alternative prompts. From there, the prompt generation and analysis service can classify the alternative prompts using the classifier model to select a preferred prompt. Then, the prompt generation and analysis service can pass the preferred prompt through the LLM and repeat the steps above until quality is above the threshold.

As part of a selection process to identity a preferred prompt, the prompt generation and analysis service can characterize each target prompt in the set of target prompts, such as by applying each target prompt against a classifier model. Illustratively, the classifier model may correspond to a Bidirectional Encoder Representations from Transformers (BERT) classifier model. The prompt generation and analysis service can then identify a preferred prompt(s) based on the characterization (e.g., output of the classifier model) without querying the LLM with the target prompts.

Illustratively, the classifier model can be configured based on application of training data. More specifically, the classifier model may be trained using training data based on a generated set of training prompts, input data, and corresponding output data from an LLM. The set of training prompts may be pre-written, as described in further detail below. A prompt analysis component can characterize output from an LLM and corresponding training prompts according to whether the output content is an appropriate application for the function indicated in the prompt. The classifier model can then be trained on the characterized training prompts, input data, and corresponding output.

In order to generate the training data to train the classifier model, the prompt generation and analysis service can generate outputs associated with each training prompt in the set of training prompts by passing the individual training prompts and other relevant input data through the LLM using the generated set of training prompts and input data. With reference to the illustrative example, the output from the LLM may be one of a selected set of categories for characterizing tone in input data (e.g., a text transcription of a speaker). For example, the LLM may output categories such as “Positive,” “Negative,” or “Neutral.” Additionally, in some examples the LLM may output numerical values that can be indicative of a perceived confidence value of the characterization, a measure of degree in the characterization, and the like. In some examples, the LLM may also generate unexpected or irrelevant information, which may be indicative of hallucinations or poor performance of the target prompt.

The prompt generation and analysis service can further characterize each output from the LLM (based on the training prompt) as compared to the expected output or ground truth for the training input data. The characterization may be based on a determination that the output reflects appropriate application of the function of the corresponding prompt to the input data. In one embodiment, the determination may be made based on the ground truth (e.g., the ideal expected result) of the output. For example, in the case of identifying the tone of a speaker, the output may appropriately indicate that the tone was “Positive” where the ground truth is also “Positive.” Therefore, the prompt generation and analysis service can characterize that output as appropriately indicating the tone of the speaker using the corresponding prompt. The training prompt, input data, and output can then be classified and labeled according to the comparison between the output and the expected output or ground truth. The labeled data can then be used to train the classifier model.

Once the classifier model is trained (e.g., according to the process described above), the prompt generation and analysis service may utilize the classifier model to process and characterize a subset of target prompts. As described above, the prompt generation and analysis service can generate a set of target prompts (e.g., candidate prompts for the preferred prompt) including one or more prompts to perform a function for an LLM. Generally speaking, the prompts may be a natural language question or statement. For example, the prompts may be a natural language question asking the LLM to determine the tone of a speaker of a text transcript. The set of target prompts can include variations in the amount of text, the structure of the natural language, the terminology used in the prompt and various combinations thereof. In one example, the set of target prompts may be based on a template that is populated with terms. The terms may be selected from a pool of potential terms and may include random selection processes. One or more target prompts may be manually written by a human and selected for use by the prompt generation and analysis service on a random basis. For example, the prompt generation and analysis service may have a data store storing a number of human written prompts for performing a function with an LLM. Still further, the set of target prompts can include prompts that have been previously used to service requests or previously designated default/preferred prompts (based on previous analysis of the prompt generation and analysis service). The prompt generation and analysis service may select, as an example, a fixed number of prompts from the generated prompts. However, in another embodiment, the prompts may be generated in a random manner by the system and subsequently selected at random from the generated prompts. In another embodiment, the prompts may also be generated by the LLM. For example, by inputting to the LLM “Give me n variations on this prompt:”.

By way of illustrative example, in one aspect the prompt generation and analysis service can be configured to manage prompts for an LLM to characterize tone attributes of input data, such as transcribed text. In this regard, the characterization of tone can be identified as the function to be elicited by the submission of the prompt with the input data (e.g., the transcribed text). According to one or more aspects, the prompt generation and analysis service can generate a set of target prompts in which each individual prompt is a selection of natural language attempting to cause outputs from the LLM corresponding to the characterization of tone.

The classifier model can process each prompt in the set of target prompts and output a value representing a classification corresponding to each prompt. The classifier model can generate an output characterizing the set of target prompts without requiring processing of the set of target prompts by the LLM. In one embodiment, the input to the classifier model may be a concatenation of each prompt with the input data. The output value may be a numerical value representing the classification. For example, in one embodiment, a higher numerical value as output from the classifier model may indicate a prompt with a higher level of accuracy in its corresponding LLM output. However, this is not meant to be limiting or required. Other possibilities of output from the classifier model are possible, such as text indicating the classification.

Based on the output of the classifier model, the prompt generation and analysis service can form at least a subset of the set of target prompts, where each prompt in the subset has an indication of the corresponding characterization of each prompt. Illustratively, the subset of target prompts can correspond to the set of target prompts. Alternatively, the prompt generation and analysis service can filter, drop or ignore one or more of the target prompts, such as based on filtering criteria. The prompt generation and analysis service may identify preferred prompt(s) based on the subset, such as via a scoring of each individual prompt. For example, in the example of a numerical output from the classifier model, the prompt generation and analysis service may determine a preferred prompt according to the prompt with the highest output. In some cases, it may be possible for there to be one preferred prompt, multiple preferred prompts, or no preferred prompts. The prompt generation and analysis service may identify one single prompt or multiple prompts that are preferred. In one embodiment, the prompt generation and analysis service may determine that none of the prompts are acceptable.

The determination may depend on the configurations of the prompt generation and analysis service. For example, in one embodiment, the prompt generation and analysis service may determine preferred prompts based on a preset threshold, such as a numerical cut-off for acceptable prompts. Specifically, the prompt generation and analysis service may reject any prompts with an output from the classifier model below a certain number, according to the preset threshold. In another embodiment, the prompt generation and analysis service may select prompts associated with the highest n number of outputs. For example, the prompt generation and analysis service may identify the prompts associated with the top five outputs as the preferred prompts. However, this is not meant to be limiting or required. Other possible configurations for determining preferred prompts based on the classifier model output may be possible.

In one embodiment, if the prompt generation and analysis service does not identify any preferred prompts, the prompt generation and analysis service may alternatively begin the above-described process once again on a different set of prompts to attempt to identify preferred prompt(s) for the function.

Although aspects of the present disclosure will be described with regard to illustrative network components, interactions, and routines, one skilled in the relevant art will appreciate that one or more aspects of the present disclosure may be implemented in accordance with various environments, system architectures, customer computing device architectures, and the like. Similarly, references to specific devices, such as a customer computing device, can be considered to be general references and not intended to provide additional meaning or configurations for individual customer computing devices. Additionally, the examples are intended to be illustrative in nature and should not be construed as limiting. Still further, as indicated above, one or more aspects of the present application will be described with regard to the management of prompts for purposes of identifying preferred prompts associated with the tone analysis for inputted transcribed text as the identified function. However, one skilled on the relevant art will appreciate that the identified functions are not limited to tone analysis. Accordingly, the disclosed examples are illustrative in nature and should not be construed as limiting unless specifically indicated.

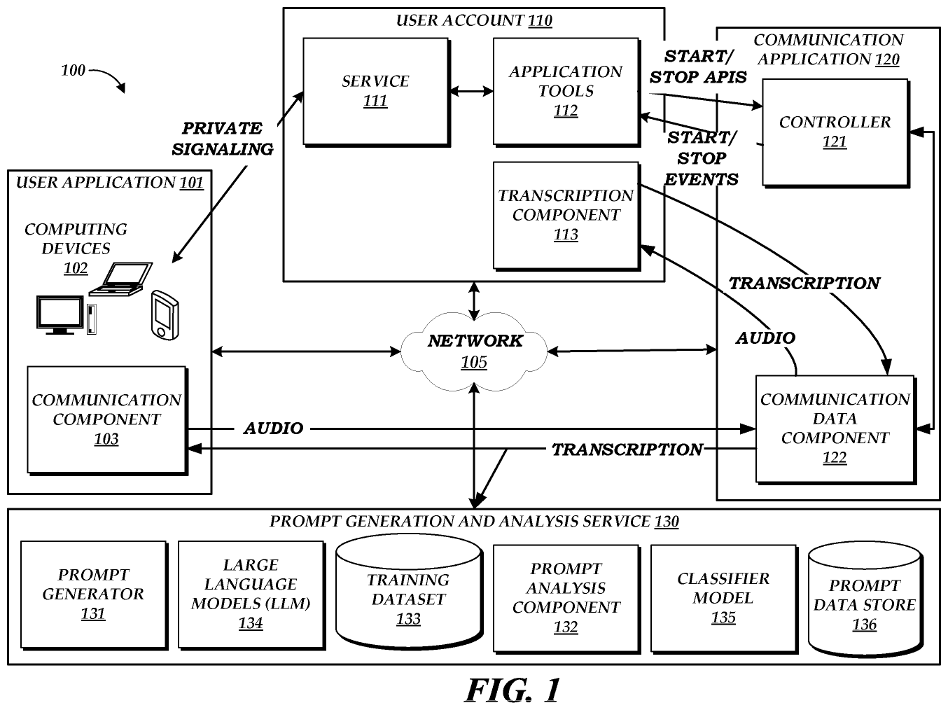

Turning to the figures, FIG. 1 depicts a block diagram of an example environment 100 for a prompt generation and analysis service 130 in communication with various components of an example transcription service including a user application 101, a portion of network resources associated with a user account 110, and a communication application 120. The environment 100 can include a network 105, the network connecting the components of the environment 100. The prompt generation and analysis service 130 may include a prompt generator 131, a prompt analysis component 132, a training dataset 133, one or more large language models (LLM) 134, a classifier model 135, and a prompt data store 136. The user application 101 may include computing devices 102 and a communication component 103.

For purposes of an illustrative example, the example environment 100 also depicts various components (e.g., network services) that can also be utilized to collect, process or otherwise generate the input data for use in the LLM, illustrative transcribed text or other input (e.g., sound data, etc.). The user account 110 may include a service 111, application tools 112, and a transcription component 113. The communication application 120 may include a controller 121 and a communication data component 122. In this regard, the specification of these additional components are illustrative in nature and may be replaced with alternative or different components.

The communication component 103 of the user application 101 may include a computer-based application that allows end users, utilizing the computing devices 102, to communicate. For example, the communication component 103 may include mechanisms for sharing content or sending and receiving audio or video calls between end users of the application 101. The portion of network resources associated with a user account 110 represents various configurations for an end user of the application 101. The portion of network resources associated with a user account 110 may include a transcription component 113 that transcribes the audio from an end user (e.g., transcribes the end user's speech into a text transcription). The user application 101 may use private signaling to interact with the components of the portion of network resources associated with a user account 110.

The communication application 120 may be a computer-based application facilitating the communication between end users of the user application 101. The controller 121 can be used to implement the functions of the communication application 120. The application tools 112 of the user account 110 may interact with the communication application 120 via the controller 121. The application tools 112 may send start and stop APIs to the controller 121 and the controller 121 can send start/stop events back to the application tools 112. These start and stop events represent, for example, the beginning and end of a user communication. For example, the start event may be a video call beginning and the stop event may be the video call ending.

The communication data component 122 represents a component including the data associated with a communication happening between the end users of the application 101. For example, the communication data component 122 may include the data associated with a computerized meeting (e.g., audio/video call) between the end users. The communication data component 122 may communicate with the transcription component 113 of the user account 110. The communication data component 122 can send audio (e.g., of a meeting) to the transcription component 113, which can transcribe the audio. The audio may originate from the communication component 103 of the user application 101. The transcription component 113 then sends the transcription back to the communication data component 122. The communication data component 122 can also send the transcription to the communication component 103 and also to the prompt generation and analysis service 130 for use in prompt analysis. The prompt generation and analysis service 130 may use the transcription as input to the LLM 134.

The prompt generation and analysis service 130 utilizes various components, as depicted in FIG. 1, to generate and analyze prompts in order to identify preferred prompt(s) to perform a function of an LLM. The prompt generation and analysis service 130 can first use the prompt generator 131 to generate prompts and/or select prompts for analysis. These generated prompts can be candidates for a preferred prompt to perform a function of the LLM 134.

In one embodiment, the prompt generator 131 may access prompts from the prompt data store 136. The prompt data store 136 can store information related to prompts to perform a function of an LLM. Optionally, the prompt data store 136 may contain prompts stored from previously identified preferred prompts of the prompt generation and analysis service 130. Alternatively, or in addition, the prompt data store 136 may contain pre-written prompts ready for use with an LLM, such as previously generated prompts by the prompt generation and analysis service 130 or human written prompts. Alternatively, or in addition, the prompt generator 131 may generate new prompts on the fly, as opposed to accessing prompts from the prompt data store 136. Illustratively, the prompt generation and analysis service 130 can include additional components for use in the generation of the training or target sets of prompts, including LLMs or other language generation modules.

After accessing from the data store 136 or generating the prompts, the prompt generator 131 may select the training prompts to be used for eventually training the classifier model. In one embodiment, the training prompts may be selected for use by the prompt generation and analysis service on a random basis. For example, the prompt generator 131 may access from the prompt data store 136 a number of human written prompts for performing a function with an LLM. The prompt generator 131 may select, as an example, six prompts from the prompts in the data store at random to use for analysis. However, in another embodiment, the training prompts may be generated in a random manner by the system and subsequently selected at random. In one embodiment, prompt generator 131 may filter out prompts that may be appropriate but are otherwise to be excluded based on exclusion criteria. For example, the prompt generator 131 may identify that the prompt contains excluded words using term matching. Additionally, in some embodiments, the prompt generator 131 can further process the selected prompts to remove potential duplicates or substantially similar prompts. Following a similar process to generating and selecting the training set of prompts, the prompt generator 131 may also generate and select a target set of prompts.

The prompt generation and analysis service 130 can use large language models (LLMs) 134 to generate output in response to a set of prompts. Specifically, the LLMs 134 can be any trained machine learning model that utilizes deep learning algorithms to process and understand natural language queries or prompts and generates outputs (e.g., texts, images, audio, video, etc.). The LLMs 134 may be trained on a large corpus of data. Moreover, LLMs may be transformer-based networks or other self-attention based networks (e.g., an encoder-decoder transformer architecture or decoder-only transformer architecture). Moreover, the LLMs 134 may process or compute an assortment of language tasks, such as translating languages, analyzing sentiments, chatbot conversations, and more. The LLMs 134 may process or compute conversational textual data, identify one or more entities and relationships between them, and generate new text that is coherent and grammatically accurate.

As described herein, the prompt generation and analysis service 130 may utilize the LLMs 104 to process a transcription based on a prompt and generate an output to perform an identified function indicated in the prompt. For example, the prompt may ask the LLM to process input data (e.g., transcribed text) and the output may indicate a characterization tone of the speaker. The prompt can also include additional input information, such as audio recordings, historical information, profile information, geographic identifiers, and the like. Additionally, the prompt can also include information that can identify the type or formatting of the generated output.

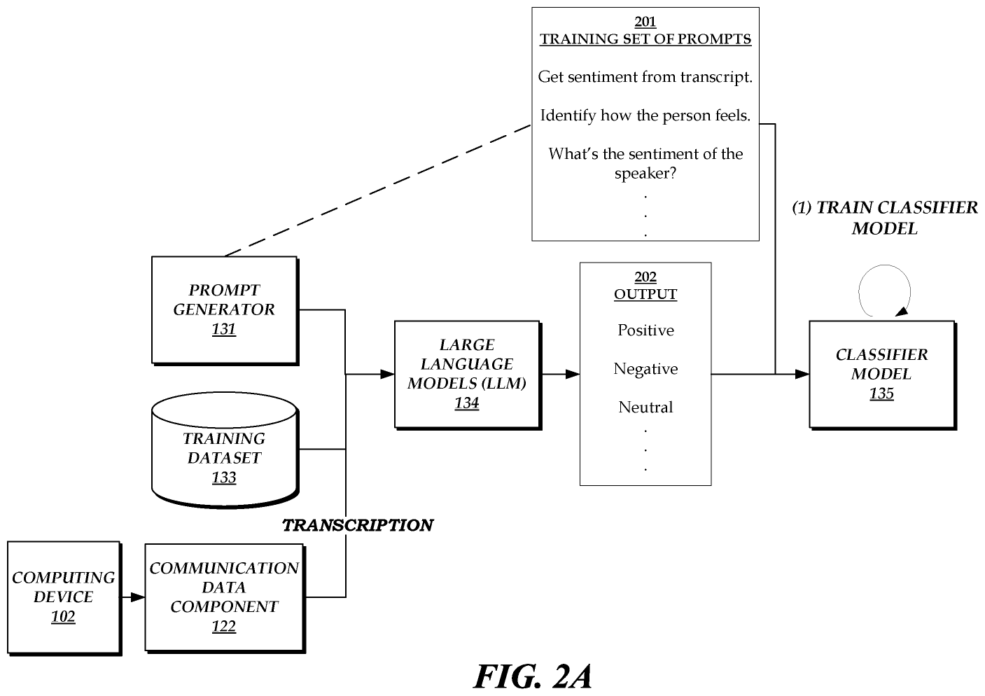

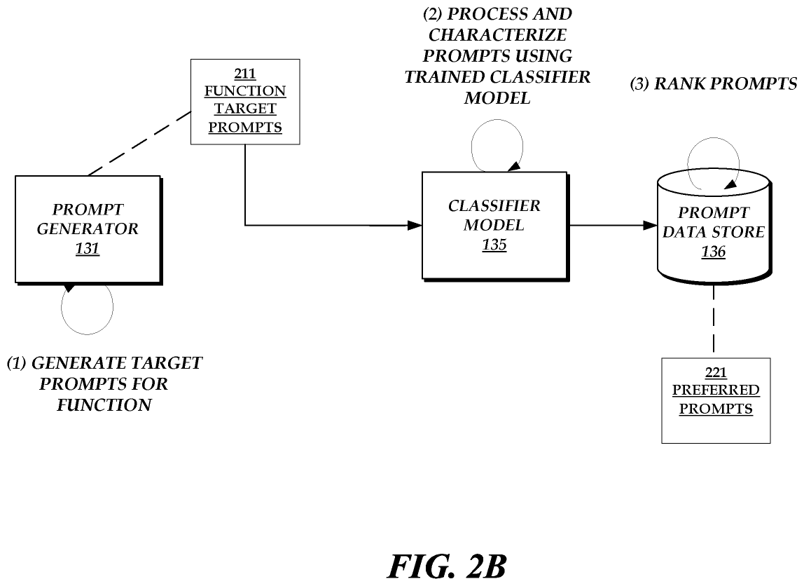

The prompt analysis component 132 can characterize the output from the LLMs 134 and the corresponding training prompts from the prompt generator 131 according to whether the output content is an appropriate application for the function indicated in the prompt based on the input data. The classifier model 135 can then be trained on the characterized training prompts and corresponding input data and LLM output. Once, the classifier model is trained, the prompt generator 131 can generate a set of target prompts for analysis. The classifier model 135 can output an indication or value associated with each input and associated target prompt. In this regard, the prompt generation and analysis service 130 does not have to create the output from the LLM and compare the results with the target prompt. Rather, the prompt generation and analysis service 130 can rank the target prompts according to the output from the classifier model 135. Based on the ranking, the prompt generation and analysis service 130 can identify preferred prompts and optionally store the preferred prompt(s), if any, in the prompt data store 136 for future use. These processes will be described in more detail below with respect to FIG. 2A and FIG. 2B.

The various aspects associated with the prompt generation and analysis service 130 can be implemented as one or more components that are associated with one or more functions, services, machine learning models, among other components. The components may correspond to software modules implemented or executed by one or more customer computing devices, which may be separate stand-alone customer computing devices. Accordingly, the components of the prompt generation and analysis service 130 should be considered as a logical representation of the service, not requiring any specific implementation on one or more customer computing devices. Moreover, the components, modules, functions, or services of the prompt generation and analysis service 130 may be implemented completely within the computing devices 102. For example, a user of a computing device 102 may utilize the components, modules, functions, or services, of the prompt generation and analysis service 130 completely within a computing environment of the computing device 102 (e.g., to perform validation of LLM generated output, etc.).

The computing devices 102 in FIG. 1 can connect to the prompt generation and analysis service 130 via the network 105 or the prompt generation and analysis service 130 can reside on the computing device 102. The computing devices 102 can send natural language questions or prompts (e.g., input from a user via a user interface (UI) of the computing devices 102) to the prompt generation and analysis service 130 and receive generated outputs from the prompt generation and analysis service 130 based on the natural language question or prompt. The computing devices 102 can be configured to have at least one processor. That processor can be in communication with the memory for maintaining computer-executable instructions. The computing devices 102 may be physical or virtual. The computing devices 102 may be mobile devices, personal computers, servers, or other types of devices. The computing devices 102 may have a display, speakers, or other output devices and input devices through which a user can interact with the user-interface component.

The network 105, as depicted in FIG. 1, connects the devices and modules of the system. The network can connect any number of devices. The network 105 may be a personal area network, local area network, wide area network, over-the-air broadcast network (e.g., for radio or television), cable network, satellite network, cellular telephone network, or combination thereof. As a further example, the network 105 may be a publicly accessible network of linked networks, possibly operated by various distinct parties, such as the Internet. In some embodiments, the network 105 may be a private or semi-private network, such as a corporate or university intranet. The network 105 may include one or more wireless networks, such as a Global System for Mobile Communications (GSM) network, a Code Division Multiple Access (CDMA) network, a Long-Term Evolution (LTE) network, or any other type of wireless network. The network 105 can use protocols and components for communicating via the Internet or any of the other aforementioned types of networks. For example, the protocols used by the network 105 may include Hypertext Transfer Protocol (HTTP), HTTP Secure (HTTPS), Message Queue Telemetry Transport (MQTT), Constrained Application Protocol (CoAP), and the like. Protocols and components for communicating via the Internet or any of the other aforementioned types of communication networks are well known to those skilled in the art and, thus, are not described in more detail herein.

FIG. 2A is a visualization of the environment of FIG. 1 depicting illustrative interactions between various components of the prompt generation and analysis service 130 and a computing device 102 for generating a training set of prompts, producing output using an LLM 134 based on the prompts, and training a classifier model in accordance with aspects of the present application. A prompt generator 131 can generate one or more training set(s) of prompts 201 associated with a function of the LLMs 134 and input data (e.g., a transcription of a speaker). The function may be a particular type of task that the LLM 134 can perform. For example, the function may be to identify the tone of a speaker of a text transcription. However, other functions of an LLM may also be possible. The prompt generator 131 may generate prompts 201 to elicit a function, such as “Get sentiment from transcript,” “Identify how the person feels,” and “What's the sentiment of the speaker?” As described above, the prompts may be pre-written by a human and obtained from the prompt data store 136 or may be generated on the fly and selected at random from the given prompts. Additionally, in one embodiment, the prompts may be generated in advance of the prompt analysis process, so the prompts to be analyzed may be already generated before the prompt generation and analysis service 130 begins. The number of training prompts selected for use can be fixed or variably determined. Also, historical prompts previously used may be added or seeded. Furthermore, additional controls, including random selection, may be utilized to ensure that the training set of prompts encompasses a wide range of possible prompts. Alternatively, the controls surrounding prompt selection can be controlled so that an admin may specify the level of change or how the variations are selected.

The computing device 102, via a communication data component 122, can send a transcription representing the text associated with speech to the LLMs 134 (e.g., via a user of the computing device 102). The transcription can be used as input to the LLM 134. Using the one or more prompts 201 from the prompt generator 131 and the transcription from the communication data component 122, the LLM 134 can generate output 202. For example, in response to a prompt asking to identify the tone of a speaker, the output from the LLM 134 may be Positive, Negative, Neutral, etc.

At this point, the generated training prompts 201, input data, and the output 202 can be used to train the classifier model 135 at (1) so that the classifier model may process and characterize prompts in the next steps as described in FIG. 2B. The classifier model 135 may be trained using training data, which is based on the generated set of training prompts 201, input data, and corresponding output data 202 from the LLM 134, where each prompt has a corresponding output. The classifier model 135 may be a type of neural network model that can classify text into categories. For example, the classifier model 135 may be a Bidirectional Encoder Representations from Transformers (BERT) classifier model.

The prompt generation and analysis service can characterize each output 202 based on the expected output or ground truth for the training input data. The characterization may be based on a determination that the output reflects appropriate application of the function of the corresponding prompt to the input data. For example, in the case of identifying the tone of a speaker, the output may appropriately indicate that the tone was “Positive” where the ground truth is also “Positive.” In some embodiments, a comparison may require a literal match (e.g., the output 202 literally duplicates the ground truth value for a given input). In other embodiments, a comparison may use other match types. For example, an output 202 my be considered to match ground truth when the output 202 and ground truth are semantically similar (e.g., according to a semantic comparison, such as a comparison of the output 202 and ground truth in a semantic vector space). Based on the comparison, the prompt generation and analysis service can characterize that output 202 as appropriately indicating the tone of the speaker using the corresponding prompt from the training set of prompts 201. Each training prompt from the training set of prompts 201 and corresponding input data and output 202 can then be classified and labeled according to the comparison between the output and the expected output or ground truth. The labeled data can then be used to train the classifier model 135.

FIG. 2B is a visualization of the environment 100 of FIG. 1 depicting illustrative interactions between the components of the prompt generation and analysis service 130 that may generate, process, and rank prompts in order to identify preferred prompt(s) for a user request, in accordance with aspects of the present application. At (1), the prompt generator 131 can generate target prompts 211 for the identified function and associated input data (e.g., transcription). As similarly described above, the function may be a particular type of task that the LLM 134 can perform and is requested by an end user. For example, the function may be to identify the tone of a speaker of a text transcription. However, other functions of an LLM may also be possible. The prompt generator 131 may generate prompts 201 to elicit a function, such as “Get sentiment from transcript,” “Identify how the person feels,” and “What's the sentiment of the speaker?” As described above, the prompts may be pre-written by a human and obtained from the prompt data store 136 or may be generated on the fly. The prompts (either pre-written or generated) may be selected at random from the appropriate prompts in the prompt data store 136 as function target prompts 211. Additionally, in one embodiment, the prompts may be generated in advance of the prompt analysis process, so the prompts to be analyzed may be already generated before the prompt generation and analysis service 130 begins. The number of prompts selected for use can be fixed or variably determined. Also, historical prompts previously used may be added or seeded. Furthermore, additional controls, including random selection, may be utilized to ensure that the target prompts encompass a wide range of possible prompts. Alternatively, the controls surrounding prompt selection can be controlled so that an admin may specify the level of change or how the variations are selected.

In one embodiment, prompt generation and analysis service 130 may filter out or process the target prompts 211. For example, the prompt generation and analysis service 130 may filter target prompts 211 associated with the output that may be appropriate but are otherwise to be excluded based on exclusion criteria. Illustratively, the prompt generation and analysis service 130 may identify that the prompt contains excluded words using term matching and therefore, exclude the prompt and corresponding output. Similarly, the prompt generation and analysis service 130 can identify and filter duplicate prompts. Still further, the prompt generation and analysis service 130 can also utilize historical data to avoid prompts that were previously attempted and were not selected.

At (2), the classifier model 135 can process and characterize the target prompts 211 as appropriately applying the function based on the input data (e.g., the transcription of FIG. 2A), where the classifier model 135 is trained as described in FIG. 2A. The classifier model 135 can generate output characterizing the target prompts 211 without requiring processing of the target prompts 211 by the LLM 134. In the case of identifying the tone of a speaker as the function, as an example, the classifier model 135 may characterize the target prompts 211 as corresponding with output appropriately indicating the tone of the speaker of an associated transcript.

In one embodiment, the target prompts 211 may be characterized by the classifier model 135 to result in a score reflecting the expected likelihood of each target prompt 211 to result in correct output, if passed with the input data to the LLM 134. The score may be a binary score, using 1 or 0 s as labels for the characterization. In another embodiment, the score is non-binary, such as a scalar value that indicates a relative expectation among different prompts that each prompt will correctly prompt the LLM 134 to produce a desired output.

At (3), the prompt generation and analysis service 130 ranks the prompts based on the output of the classifier model 135. The prompt generation and analysis service 130 may identify preferred prompt(s) based on ranking, which can be passed to an LLM with the corresponding input data. For example, in the case of a numerical output from the classifier model, the prompt generation and analysis service 130 may determine a preferred prompt according to the prompt with the highest output. The prompt generation and analysis service 130 may identify one single prompt or multiple prompts that are preferred and set the prompt(s) as the default prompt(s). In one embodiment, the prompt generation and analysis service 130 may determine that none of the prompts are acceptable. For example, in one embodiment, the prompt generation and analysis service 130 may determine preferred prompts based on a preset threshold, such as a numerical cut-off for acceptable prompts. Specifically, the prompt generation and analysis service 130 may reject any prompts with an output from the classifier model 135 below a certain number, according to the preset threshold. In another embodiment, the prompt generation and analysis service 130 may select target prompts associated with the highest n number of outputs. For example, the prompt generation and analysis service 130 may identify the prompts associated with the top five outputs as the preferred prompts. In another embodiment, the prompt generation and analysis service 130 may select target prompts as a default prompt for the identified function by selecting one or more prompts based on a comparison to a historical set of prompts and the rankings. With this filtering, it is possible that the prompt generation and analysis service 130 may not identify any prompts that meet the criteria and therefore, the prompt generation and analysis service 130 will not select any prompts for storage in the prompt data store 136.

In one embodiment, after identifying the preferred prompts, if any, the prompt generation and analysis service 130 may store the preferred prompts in the prompt data store 136. The prompts stored in the prompt data store 136 can be used again in future requests to the LLM for the identified function. Therefore, in subsequent requests to the LLM, the system need not generate and identify preferred prompts again in order to achieve appropriate results. As previously discussed, by reducing the identified prompt (including to a single prompt), the processing of the subsequent requests provides significant computational efficiencies and performance benefits for the prompt generation and analysis service.

In embodiments in which preferred prompts are stored, the system may then use the preferred prompts to query the LLM for future requests of the function and input data and therefore, receive a higher quality output from the LLM as a result. However, if the prompt generation and analysis service 130 does not identify any preferred prompts (e.g., the generated prompts 201 are unacceptable), the prompt generation and analysis service 130 may alternatively begin the above-described process once again on a different set of prompts to attempt to identify one or more preferred prompt(s) using a different set of prompts. In subsequent processes, the prompt generation and analysis service 130 may attempt to add more context to the prompts to improve the appropriateness of the corresponding output from the LLM. For example, the prompt generation and analysis service 130 may include more of a detailed textual description of the desired function or desired output to the target prompt, such as more specific language in the prompt. In another example, the prompt generation and analysis service 130 can submit additional or different input data in combination with modified prompts, such as different amounts of transcription data, additional user profile data, and the like.

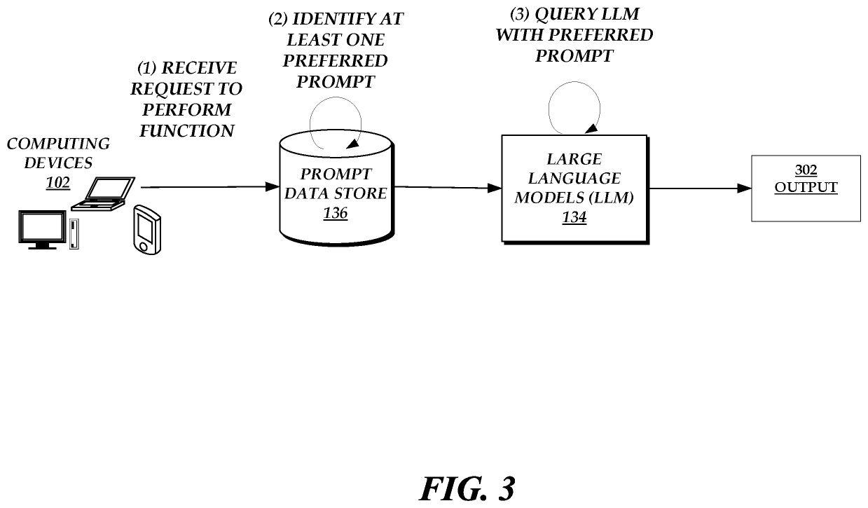

FIG. 3 is a visualization of the environment 100 of FIG. 1 depicting illustrative interactions between components of the prompt generation and analysis service 130, the LLM 134, and a computing device 102 that may query the LLM 134 with an identified preferred prompt, in accordance with aspects of the present application. At (1), the prompt generation and analysis service 130 may receive a request to perform a function (e.g., identify tone of a speaker) from the computing devices 102. For example, the request may be a request to identify the tone of a speaker of a call transcription. However, this is not meant to be limiting or required. The computing devices 102 may request to perform other functions beyond tone identification.

In the request to perform a function, an end user can interact with interfaces or submit additional information to either directly identify a function (e.g., from a list of functions) or can provide textual information in the prompt that identifies the function. In the case of a user providing the prompt identifying the function (at least in part), the prompt generation and analysis service 130 may use logic to match the prompt to the function (e.g., check that the prompt is “correct”). The logic may be implemented using an LLM, semantic classification, or the like.

At (2), the prompt generation and analysis service 130 identifies at least one preferred prompt for performing the function based on the input data from the prompt data store 136. The prompt generation and analysis service 130 may identify the preferred prompt by performing the steps as described in FIG. 2A and FIG. 2B. For example, the prompt generation and analysis service 130 may determine (e.g., through the processes described in FIG. 2A and FIG. 2B) that the prompt “What is the sentiment of the speaker?” resulted in the preferred output from the LLM. Optionally, the prompt generation and analysis service 130 may have stored this prompt in the prompt data store 136. The prompt generation and analysis service 130 can then identify “What is the sentiment of the speaker” as the preferred prompt to be used for this function.

At (3), the prompt generation and analysis service 130 queries the LLMs 134 with the preferred prompt identified at (2). For example, if the preferred prompt is “What is the sentiment of the speaker?”, then the prompt generation and analysis service 130 can query the LLM with “What is the sentiment of the speaker?”, along with the associated transcription from the call. In one embodiment, the prompt generation and analysis service 130 may query the LLM 134 with additional input data, such as audio data, video data, profiles, sounds, geolocation, etc. The LLM then generates output 302 indicating the function, such as the sentiment of the speaker. For example, the output 302 may be “Positive,” “Negative,” or “Neutral.”

As discussed above, identifying a preferred prompt without requiring submission of multiple potential prompts or variations of prompts to the LLM provides significant computational resource savings. This is because the prompt generation and analysis service only submits the preferred prompt to the LLM instead of consuming significantly more computational resources submitting multiple prompts or multiple versions of a prompt to the LLM. Rather, the user can submit a request to the system to perform a function, which will identify a preferred prompt, and which results in a single pass of the preferred prompt to the LLM.

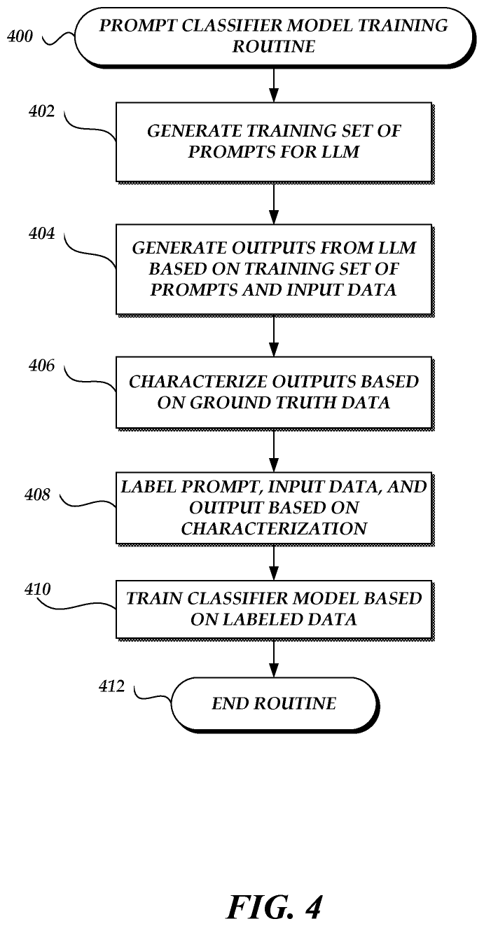

FIG. 4 is a flow diagram illustrative of a routine 400 for training a classifier model, in accordance with aspects of the present application. The routine 400 may begin automatically upon initiating a device (e.g., a computing device 102), or may be initiated by a client or end-user on an ad hoc basis. The client or end-user may use an interactive system to initiate the routine 400. For example, a client or end-user may request the analysis of prompts for an identified function of an LLM or request an identified function of an LLM. The routine 400 may also be initiated automatically based on a routine schedule (e.g., every hour, day, or week, etc.), in response to a triggering event, or both. For example, a routine schedule may set the routine 400 to automatically be performed every week and therefore, the routine 400 may be performed every week according to the set schedule. Additionally, a triggering event, for example, may be a new transcription event, an added prompt event, etc., where an event occurrence in the network triggers initiation of the routine 400.

The routine 400 may be embodied in a set of executable program instructions stored on a computer-readable medium, such as one or more disk drives of a computing system of a node or a server. When the routine 400 is initiated, the executable program instructions can be loaded into memory, such as random access memory (“RAM”), and executed by one or more processors of a computing system, such as the prompt generation and analysis service 130 shown in FIG. 7.

The routine 400 begins at block 402, where the prompt generation and analysis service 130 generates a set of training prompts for an LLM for an identified function. The prompts may be natural language text (e.g., a statement or question) for performing a function of the LLM. The function may be requested from an end user, such as identifying the tone of a speaker of a text transcription. The prompt generation and analysis service 130 may access pre-written prompts that are stored in a data store and randomly selects a subset of those prompts for use. The pre-written prompts may be human generated, where the function may be specified as an attribute or seeded with a single human generated prompt. The prompt generation and analysis service 130 may also create the prompts on the fly (e.g., using an LLM) and randomly select a subset of the prompts generated on the fly.

At block 404, the prompt generation and analysis service 130 generates outputs from the LLM based on the training prompts generated at block 402 and input data. As previously discussed, the LLM can generate an output based on applying the prompt (as processed) and the corresponding input data. The output can include answers to natural language questions prompts, references (e.g., including URL, date accessed, and name of references), and the like.

At block 406, the prompt generation and analysis service 130 characterizes the output as reflecting appropriate application of the indicated function based on ground truth data. Each function has associated ground truth data and input data that are provided as input to this process The output from the LLM can be compared to an expected value (or ground truth). For example, the characterization may be based on whether the output is an appropriate response to the function indicated in the prompt. In one embodiment, whether the output is appropriate may depend on the ground truth (e.g., the ideal expected result). For example, if the output matches the ground truth, then it is characterized as appropriate. In the example of tone as the identified function, appropriate output would be where the output is “Positive” and the ground truth is “Positive” as the identified tone of the speaker. Otherwise, the output is characterized as inappropriate. The prompt generation and analysis service 130 can utilize a classifier model to evaluate the set of generated outputs corresponding to the set of training prompts.

At block 408, the prompt generation and analysis service 130 labels each associated prompt, input data, and output based on the characterizations from block 406. In one embodiment, the training prompts may be characterized using a score based on the appropriateness of the output associated the training prompts and input data. The training prompts may then be labeled based on the score. The score may be a binary score, using 1 or 0 s as labels for the characterization. For example, the score may be 1 for a correct output (e.g., the output is “Positive” and the ground truth is “Positive”), or a 0, for an incorrect output (e.g., the output is “Positive” and the ground truth is “Negative”). However, this is not intended to be required or limiting. Other labels of the prompt and output pairs may also be possible.

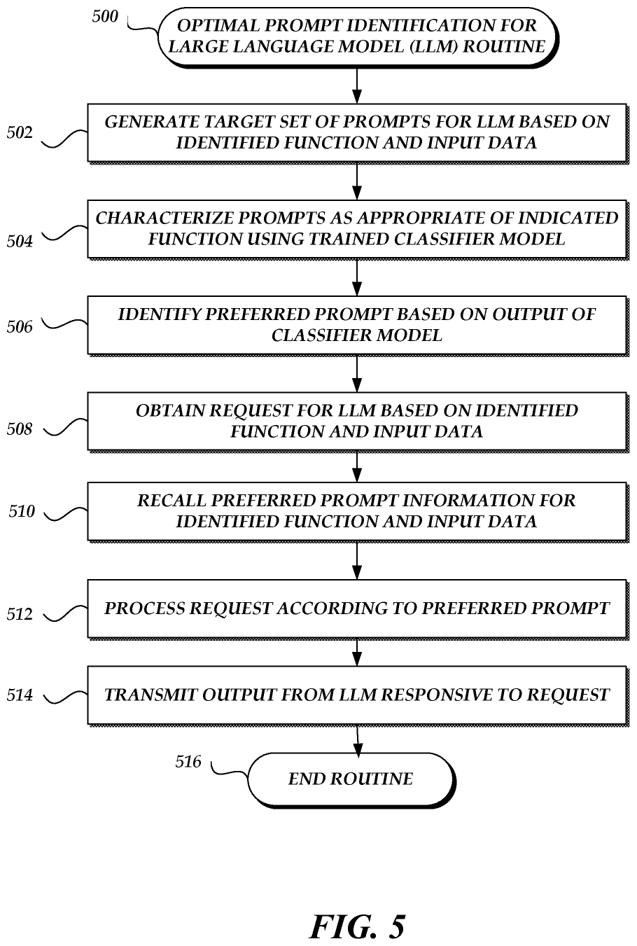

At block 410, the prompt generation and analysis service 130 trains a classifier model based on the labeled data. The labeled data can be used as a training set for the classifier model, where the training data is based on the generated set of training prompts, input data, and corresponding output data from the LLM. The trained classifier model may then be used to characterize target prompts, such as will be described with respect to FIG. 5.

The routine ends at block 412.

FIG. 5 is a flow diagram illustrative of a routine 500 for the preferred prompt identification for an LLM and for processing a request based on an identified function using the preferred prompt, in accordance with aspects of the present application. The routine 500 may begin automatically upon initiating a device (e.g., a computing device 102), or may be initiated by a client or end-user on an ad hoc basis. The client or end-user may use an interactive system to initiate the routine 500 by requesting the analysis of prompts for an identified function of an LLM or request an identified function of an LLM using input data. Additionally, a triggering event, for example, may be a new transcription event, an added prompt event, etc., where an event occurrence in the network triggers initiation of the routine 500.

The routine 500 may be embodied in a set of executable program instructions stored on a computer-readable medium, such as one or more disk drives of a computing system of a node or a server. When the routine 500 is initiated, the executable program instructions can be loaded into memory, such as random access memory (“RAM”), and executed by one or more processors of a computing system, such as the prompt generation and analysis service 130 shown in FIG. 7.

The routine 500 begins at block 502, where the prompt generation and analysis service 130 generates a set of target prompts for an LLM for an identified function and corresponding input data. The prompts may be natural language text (e.g., a statement or question) for performing a function of the LLM. The function may be requested from an end user, such as identifying the tone of a speaker of a text transcription. The prompt generation and analysis service 130 may access pre-written prompts that are stored in a data store and randomly selects a subset of those prompts for use. The pre-written prompts may be human generated, where the function may be specified as an attribute or seeded with a single human generated prompt. The prompt generation and analysis service 130 may also create the prompts on the fly and randomly select a subset of the prompts generated on the fly.

At block 504, the prompt generation and analysis service 130 characterizes the target prompts as reflecting appropriate application of the indicated function to the input data using the trained classifier model, such as the classifier model described in FIG. 4. The classifier model may generate output characterizing the set of target prompts without requiring processing of the set of target prompts by the LLM. The characterization from the classifier model can be used to form a ranked list of target prompts. For example, the characterization may be based on whether the output is an appropriate response to the function indicated in the prompt. Based on the characterization (e.g., from the trained classifier model), the prompt generation and analysis service 130 can then utilize the rankings to identify a default prompt for the identified function, described below with respect to block 506.

At block 506, the prompt generation and analysis service 130 identifies a preferred prompt based on the output of the classifier model. The classifier model predicts whether the prompts belong in a certain category. For example, the classifier model may be a type of neural network model that can classify text into categories, such as a BERT classifier model. In one embodiment, the classifier model may be trained as described in FIG. 4. In some embodiments, the prompt generation and analysis service 130 may identify more than one preferred prompts if more than one prompt meets specified criteria or no preferred prompts if none of the prompts meet the specified criteria.

The classifier model can process each prompt from block 502 and output a value corresponding to each prompt that can be used to determine the preferred prompt(s). Additionally, the prompt generation and analysis service 130 may rank the prompts based on the output of the classifier model. Using the ranking, the prompt generation and analysis service 130 can identify the preferred prompt(s), if any. Once the prompt generation and analysis service 130 identifies the preferred prompts, it can store the preferred prompts in a data store for future use. For example, the classifier model may output a numerical value associated with each prompt. In this case, the prompt generation and analysis service 130 may determine a preferred prompt according to the prompt with the highest output.

At block 508, the prompt generation and analysis service 130 obtains a request to perform a function (e.g., identify tone of a speaker) with an LLM based on input data, such as from the computing devices 102 of FIG. 1. For example, the request may be a request to identify the tone of a speaker of a call transcription. However, this is not meant to be limiting or required. The identified function may be other functions beyond tone identification.

At block 510, the prompt generation and analysis service 130 recalls information about at least one preferred prompt for performing the identified function corresponding to the input data, such as from the prompt data store 136 of FIG. 1. For example, the prompt generation and analysis service 130 may have determined (e.g., through the processes described in the previous blocks) that the prompt “What is the sentiment of the speaker?” corresponded with preferred output from the LLM. The prompt generation and analysis service 130 can then recall “What is the sentiment of the speaker” as the preferred prompt to be used for this function.

At block 512, the prompt generation and analysis service 130 processes the request according to the preferred prompt recalled at block 510. For example, the prompt generation and analysis service 130 may query the LLMs 134 with the preferred prompt. As previously discussed, the LLM can generate an output content based on applying the prompt (as processed). The output content can include answers to natural language questions, prompts, references (e.g., including URL, date accessed, and name of references), and the like. However, using the preferred prompt provides more certainty that the output of the LLM is appropriate of the identified function in the prompt. For example, if the preferred prompt is “What is the sentiment of the speaker?”, then the prompt generation and analysis service 130 can query the LLM with “What is the sentiment of the speaker?”, along with the associated transcription from the call. In one embodiment, the prompt generation and analysis service 130 may query the LLM 134 with additional input data, such as audio data, video data, profiles, sounds, geolocation, etc. The LLM then generates output indicating the function, such as the sentiment of the speaker. For example, the output 302 may be “Positive,” “Negative,” or “Neutral.”

At block 514, the prompt generation and analysis service 130 transmits the output from the LLM responsive to the request. For example, in the case of identifying tone, the LLM may output “Positive” and therefore, the prompt generation and analysis service 130 transmits “Positive” in response to the request to identify tone of a speaker.

The routine ends at block 516. By identifying a preferred prompt using the above described routine before querying an LLM, computational effort is saved as the user need only query the LLM once rather than attempting to query the LLM with multiple prompts until the preferred output is returned.

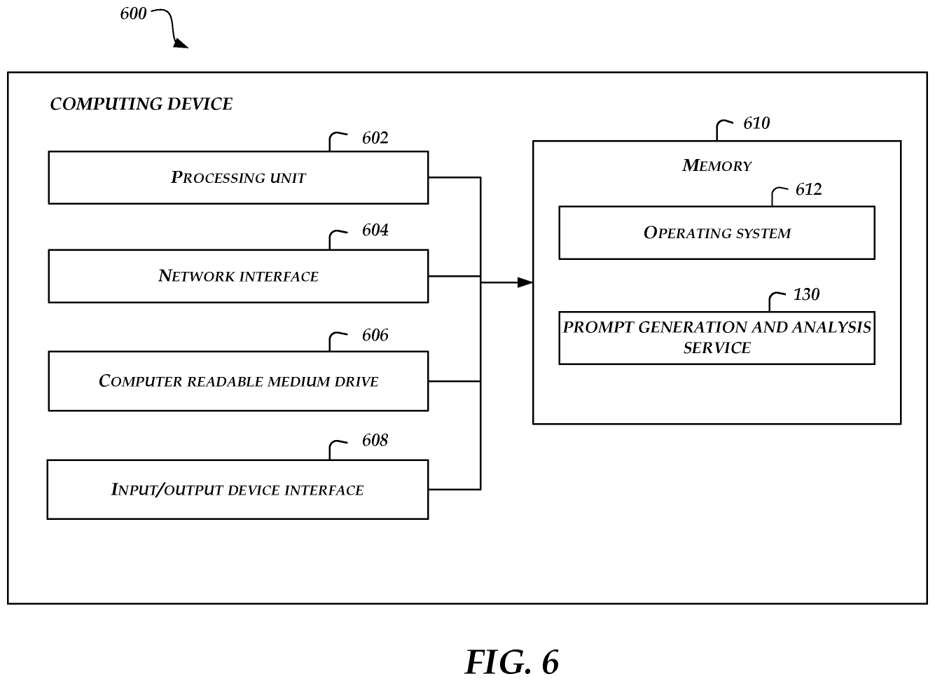

FIG. 6 depicts an example architecture of a computing system (referred to as a computer device 600) that can be used to perform one or more of the techniques described herein or illustrated in FIGS. 1-5. The general architecture of the computing device 600 depicted in FIG. 6 includes an arrangement of computer hardware and software modules that may be used to implement one or more aspects of the present disclosure. The computing device 600 may include many more (or fewer) elements than those shown in FIG. 6. It is not necessary, however, that all of these elements be shown in order to provide an enabling disclosure. As illustrated, the computing device 600 includes a processing unit 602, a network interface 604, a computer readable medium drive 606, and an input/output device interface 608, all of which may communicate with one another by way of a communication bus. The network interface 604 may provide connectivity to one or more networks or computing systems. The processing unit 602 may thus receive information and instructions from other computing systems or services via a network (e.g., connecting the computing device 600 and the environment 100).

The processing unit 602 may also communicate with memory 610. The memory 610 may contain computer program instructions (grouped as modules or units in some embodiments) that the processing unit 602 executes in order to implement one or more aspects of the present disclosure. The memory 610 may include random access memory (RAM), read only memory (ROM), and/or other persistent, auxiliary, or non transitory computer readable media. The memory 610 may store an operating system 612 that provides computer program instructions for use by the processing unit 602 in the general administration and operation of the computing device 600. The memory 610 may further include computer program instructions and other information for implementing one or more aspects of the present disclosure. For example, in one embodiment, the memory 610 includes a user interface module that generates user interfaces (and/or instructions therefor) for display upon a user computing device, e.g., via a navigation and/or browsing interface such as a browser or application installed on the user computing device.

In addition to and/or in combination with the operating system 612, the memory 610 includes a prompt generation and analysis service 130, which may implement the functionality of the present disclosure.

While the prompt generation and analysis service 130 is shown in FIG. 7 is part of the computing device 600, in other embodiments, all or a portion of the prompt generation and analysis service 130 may be implemented by another computing device. For example, in certain embodiments of the present disclosure, another computing device in communication the computing device 600 may include several modules or components that operate similarly to the modules and components illustrated as part of the computing device 600. In some instances, the prompt generation and analysis service 130 may be implemented as one or more virtualized computing devices. Moreover, the prompt generation and analysis service 130 may be implemented in whole or part as a distributed computing system including a collection of devices that collectively implement the functions discussed herein.

Depending on the embodiment, certain acts, events, or functions of any of the processes or algorithms described herein can be performed in a different sequence, can be added, merged, or left out altogether (e.g., not all described operations or events are necessary for the practice of the algorithm). Moreover, in certain embodiments, operations or events can be performed concurrently, e.g., through multi-threaded processing, interrupt processing, or multiple processors or processor cores or on other parallel architectures, rather than sequentially.

The various illustrative logical blocks, modules, routines, and algorithm steps described in connection with the embodiments disclosed herein can be implemented as electronic hardware, or combinations of electronic hardware and computer software. To clearly illustrate this interchangeability, various illustrative components, blocks, modules, and steps have been described above generally in terms of their functionality. Whether such functionality is implemented as hardware, or as software that runs on hardware, depends upon the particular application and design constraints imposed on the overall system. The described functionality can be implemented in varying ways for each particular application, but such implementation decisions should not be interpreted as causing a departure from the scope of the disclosure.

Moreover, the various illustrative logical blocks and modules described in connection with the embodiments disclosed herein can be implemented or performed by a machine, such as a processor device, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor device can be a microprocessor, but in the alternative, the processor device can be a controller, microcontroller, or state machine, combinations of the same, or the like. A processor device can include electrical circuitry configured to process computer-executable instructions. In another embodiment, a processor device includes an FPGA or other programmable device that performs logic operations without processing computer-executable instructions. A processor device can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor device may also include primarily analog components. For example, some or all of the algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

The elements of a method, process, routine, or algorithm described in connection with the embodiments disclosed herein can be embodied directly in hardware, in a software module executed by a processor device, or in a combination of the two. A software module can reside in RAM memory, flash memory, ROM memory, EPROM memory, EEPROM memory, registers, hard disk, a removable disk, a CD-ROM, or any other form of a non-transitory computer-readable storage medium. An exemplary storage medium can be coupled to the processor device such that the processor device can read information from, and write information to, the storage medium. In the alternative, the storage medium can be integral to the processor device. The processor device and the storage medium can reside in an ASIC. The ASIC can reside in a user terminal. In the alternative, the processor device and the storage medium can reside as discrete components in a user terminal.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements or steps. Thus, such conditional language is not generally intended to imply that features, elements or steps are in any way required for one or more embodiments or that one or more embodiments necessarily include logic for deciding, with or without other input or prompting, whether these features, elements or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, or Z). Thus, such disjunctive language is not generally intended to, and should not, imply that certain embodiments require at least one of X, at least one of Y, and at least one of Z to each be present.

Unless otherwise explicitly stated, articles such as “a” or “an” should generally be interpreted to include one or more described items throughout this application. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C. Unless otherwise explicitly stated, the terms “set” and “collection” should generally be interpreted to include one or more described items throughout this application. Accordingly, phrases such as “a set of devices configured to” or “a collection of devices configured to” are intended to include one or more recited devices. Such one or more recited devices can also be collectively configured to carry out the stated recitations. For example, “a set of servers configured to carry out recitations A, B and C” can include a first server configured to carry out recitation A working in conjunction with a second server configured to carry out recitations B and C.

While the above detailed description has shown, described, and pointed out novel features as applied to various embodiments, it can be understood that various omissions, substitutions, and changes in the form and details of the devices or algorithms illustrated can be made without departing from the spirit of the disclosure. As can be recognized, certain embodiments described herein can be embodied within a form that does not provide all of the features and benefits set forth herein, as some features can be used or practiced separately from others. All changes which come within the meaning and range of equivalency of the claims are to be embraced within their scope.

What is claimed is:

1. A computing device for managing prompts utilized by large language models (LLMs), the computing device comprising:
computer-readable memory storing executable instructions; and
a processor in communication with the computer-readable memory and programmed by the executable instructions to:
generate a plurality of training prompts, wherein individual training prompts of the plurality of training prompts request that an LLM implement a function with respect to first input data;
generate, via the LLM, a plurality of outputs corresponding to the plurality of training prompts
label each training prompt and corresponding output pair from the plurality of training prompts based on whether the output matches a ground truth value corresponding to the first input data;
train a classifier model based on the labeled prompt and output pairs;
obtain a request to apply the function to second input data;
generate a set of target prompts, wherein individual prompts of the set of target prompts request that the LLM implement the function with respect to the second input data;
process the set of target prompts according to the classifier model, wherein the classifier model outputs a value indicating an expected likelihood that each target prompt, of the set of target prompts, would elicit a correct response from the LLM with respect to the second input data;
select a prompt, from the set of target prompts, according to the outputs of the classifier model;
query the LLM utilizing the selected prompt; and
transmit an output from the LLM responsive to the request.

2. The computing device of claim 1, wherein the plurality of outputs is filtered based on appropriate responses to the function for each output in the plurality of outputs to form a subset of training prompts based on corresponding outputs.

3. The computing device of claim 1, wherein labeling each training prompt and corresponding output pair includes the processor further executing instructions to:
determine a binary score of individual outputs of the plurality of outputs, the binary score indicative of an appropriate response to the function; and
label each individual output with the determined binary score.

4. The computing device of claim 1, wherein the classifier model is represented as a bidirectional encoder.

5. A computer-implemented method comprising:
generating a plurality of target prompts for use with a large language model (LLM), wherein the plurality of target prompts include language associated with an identified function with respect to input data;
forming a ranked subset of target prompts based on characterization of the generated target prompts, wherein the subset of target prompts are ranked based on application of a classifier model that generates an output characterizing the subset of target prompts without requiring processing of the subset of target prompts by the LLM; and
selecting one or more target prompts as a default prompt for the identified function based on the ranking.

6. The computer-implemented method of claim 5, wherein the classifier model is trained based on a characterized set of training prompts and corresponding LLM output pairs, wherein the set of training prompt and corresponding LLM output pairs are characterized by:
determining a score for a set of LLM outputs based on a comparison of the output to an expected output; and
labeling the individual output based on the score.

7. The computer-implemented method of claim 6, wherein the score corresponds to a binary score.

8. The computer-implemented method of claim 6, wherein the classifier model identifies hallucinated content from the set of LLM outputs.

9. The computer-implemented method of claim 5, wherein the one or more target prompts each comprise terms, wherein the terms are selected from a pool of potential terms.

10. The computer-implemented method of claim 5, wherein the one or more target prompts are a fixed number of prompts or a randomly selected number of prompts.

11. The computer-implemented method of claim 5, further comprising:
training the classifier model based on the characterization.

12. The computer-implemented method of claim 5, wherein the output characterizing the subset of target prompts corresponds to a numerical value for each target prompt indicating a level of accuracy associated with the corresponding target prompt.

13. The computer-implemented method of claim 5, wherein the identified function comprises characterizing a tone of a speaker of a text transcript.

14. The computer-implemented method of claim 5, wherein selecting the one or more target prompts as the default prompt for the identified function based on the ranking includes selecting the one or more target prompts according to a predetermined threshold of the ranking.

15. The computer-implemented method of claim 5, further comprising causing generation, via the LLM, a set of outputs corresponding to the default prompt, wherein causing generation, via the LLM, comprises inputting data into the LLM, wherein the data includes one or more of: the default prompt, profile data, audio data, or geolocation data.

16. A non-transitory computer-readable medium storing specific computer-executable instructions that, when executed by a processor, cause the processor to at least:
receive a request to submit a prompt to a large language model corresponding to an identified function with respect to input data;
identify a preferred prompt based on a ranking of one or more target prompts associated with the identified function, wherein the ranking of the one or more target prompts corresponds to application of a classifier model to select the preferred prompt from the one or more target prompts;
query an LLM utilizing the identified preferred prompt; and
generate output from the LLM.

17. The non-transitory computer-readable medium of claim 16, wherein the identified function comprises identifying a tone of a speaker of a text transcript.

18. The non-transitory computer-readable medium of claim 16, wherein querying the LLM comprises inputting data into the LLM, wherein the data includes one or more of: the preferred prompt, profile data, audio data, or geolocation data.

19. The non-transitory computer-readable medium of claim 16, further comprising filtering the preferred prompt based on characterization on application of exclusion criteria.

20. The non-transitory computer-readable medium of claim 16, wherein application of the classifier model generates a classifier output characterizing the one or more target prompts without requiring processing of the one or more target prompts by the LLM.
